(19) United States
(12) Patent Application Publication
(10) Pub. No.: US 2008/0294421 A1
(43) Pub. Date: Nov. 27, 2008

(54) Hard Disk Drive Adapter For Emulating Hard Disk Drive Interface

(76) Inventor: Kwok-Yan Leung, Willowdale (CA)

Correspondence Address: LIN & ASSOCIATES INTELLECTUAL PROPERTY, INC., P.O. BOX 2339, SARATOGA, CA, 95070-0339, US

(21) Appl. No.: 11/752,922

(22) Filed: May 23, 2007

(51) Int. Cl. G06F 9/455

(52) U.S. Cl. 703/25

(57) ABSTRACT

Adapter for emulating hard disk drive interface is designed for providing IDE interface by means of emulation without having to install any additional drivers for the motherboard which lacks IDE interface. The controller of the adapter is able to provide reply information on the manufacturer name, serial number of the equipment, and the device type of the hard disk device to which it is electrically connected, by responding to the BIOS query though the bus interface, thus emulating the control components of the hard disk drive as if they were appeared to be configured on the motherboard. Therefore, the number of hard disk interface types as compared to that originally supported by the motherboard is expanded.

### BACKGROUND OF THE INVENTION

1. Field of the Invention

The present invention relates generally to a hard disk drive adapter, and in particular, to an adapter for emulating hard disk drive interface.

2. The Prior Arts

Taiwan Patent Publication No. 480384 application “Protective circuit for protecting hard disk data” discloses the technology for protecting data stored in a storage device (i.e. a hard disk drive) using a hardware, which is characterized in the ability of directly accessing data stored in the storage device via the implementation under a hardware method by installing the disclosed device in between a conventional hard disk drive interface and a bus. In regards to any operating system, there is no noticeable difference seen between the hard disk drive using the aforementioned technology and conventional hard disk drive. Thus, this technology has no effect upon the data access efficiency; and moreover, it does not need to install additional drivers, and also will not increase the system loading, thereby able to provide a more effective data protection method than done under a software platform.

However, due to the existing limitations of conventional hardware architecture for the aforementioned technology, there is a need to support two physical or two logical Integrated Drive Electronics (IDE) interfaces simultaneously; otherwise, the remaining space other than main data space and the virtual data space cannot be accessed. Under the IDE interface, the conventional device is able to divide the remaining space into logical hard disks using the two channels provided by IDE interface, so that an user is able to use of this part of the hard disk space.

However, because the Serial Advanced Technology Attachment (SATA) interface is able to only support a single hard disk drive, therefore, the above conventional technology for protecting hard disk data thereby lacks support for the newer specifications, as it could not use the remaining space to divide into logical hard disks. Moreover, due to the technological developments requiring higher demands for bandwidth, the conventional IDE (Parallel Advanced Technology Attachment, PATA) interface will be gradually replaced by the newer specifications such as the SATA interface. Therefore, it would be necessary to provide additional PCI adapters having the IDE interface to allow the aforementioned conventional technology to be used in future computer devices. But because the aformentioned PCI adapter is not a standard PCI adapter, it cannot be recognized by the BIOS during system booting, and therefore would not be able to directly install the operating system onto to the hard disk device within the architecture for protecting hard disk data.

The BIOS, wholly refers to as the ROM-BIOS, is the acronym for “Read-Only Memory Basic Input-Output System”. A BIOS is actually a program embedded into a computer, for providing the lowest-level and the most direct hardware control for the computer. Strictly speaking, BIOS is a “converter” between the hardware and the software program, or functioning as an interface (although the BIOS itself is a program). The BIOS is responsible for solving the real-time demand of the hardware, and to perform executions according to the operation requirements from the software to the hardware.

From a functional perspective, the BIOS has three functions: 1) self test and initialization, 2) hardware interrupt handling, and 3) program service request handling.

The self test and initialization function is mainly responsible for booting the computer, which can also be divided into three steps: 1) the first step is checking hardware components after the computer is powered on, which also is called the power-on self-test (POST). The primary function of POST is to check the computer hardware for ensuring that everything is working properly, such as determining whether the memory has any faults. 2) The second step is initialization, including interrupt vector setup, register configuration, and initialization and diagnostics of various peripheral equipments, in which the BIOS setup is the most important part for the setup of the various parameters for the hardware. When the computer is booted, it reads these parameters and compares these parameters with actual hardware configurations; and if the parameters are not in accordance with the hardware configurations, the system booting process will be affected.

3) The last step is the boot loader program, whose function is to invoke the DOS or other operating system to start. The BIOS first reads the boot record from the floppy disk or hard disk; and if no boot record is found, then a “no boot device” message will be displayed on a display; and if the boot record is found, then the control of the computer is transferred to the boot record, and the operating system is loaded into the computer through the boot record. After the computer is successfully booted, this part for the functionality for the BIOS is completed.

When a computer is powered on, during its POST process, the system will first perform diagnostics of each internal device using the program. Usually, complete POST includes self diagnostics of the central processing unit (CPU), the 640 KB base memory, the expansion memory unit above 1M, the Read Only Memory (ROM), the motherboard, the complementary metal-oxide semiconductor (CMOS) RAM, the serial/parallel interface, the display adapter, the floppy/hard disk subsystem, and the keyboard. Once an error has been detected, the system will indicate an error message or an alarm beep.

A computer system may contain several BIOS firmware chips. Besides the boot BIOS (typically contains program code to access the basic hardware components such as the keyboard or floppy drives), there are additional plug-in adapters such as the small computer system interface (SCSI) adapter, the universal serial bus (USB) hard disk adapter, the network adapter, or the video adapter which also includes their own BIOS, for complementing or replacing the system BIOS codes for the given device.

To find these memory-mapped expansion ROMs during boot up, the BIOS performs a scan on the real memory from 0xC8000 to 0xF0000 on 2 kilobyte boundaries to look for a 0x55 0xaa signature, which is immediately followed by a bit indicating the number of 512 bit blocks of the expansion ROM to occupy in real memory. Then the BIOS jumps to the offset immediately after the size byte, at which point, the expansion ROM code takes over and uses the BIOS services to provide a user configuration interface, register interrupt vectors for use by post-boot applications, or display diagnostic information.

If the expansion ROM is to change the method in which the system boots (such as from a network device or a SCSI adapter, for which the BIOS has no driver code), it can use the BIOS Boot Specification (BBS) application programming interface (API) to register its capability to do so. Once the expansion ROMs have been registered using the BBS APIs, the user can select among the available boot options from within the user interface of the BIOS. This is why most BBS-compliant PC BIOS implementations do not allow the user to enter the user interface of the BIOS until the expansion ROMs have finished executing and have been registered with the BBS API.

To make the above add-on adapters controlled by the operating system, a device driver is required to be pre-installed, which is also referred to as simply the driver. The driver is a program which allows the computer software to interact with the hardware devices, by setting up a communication interface between hardware with hardware, or between hardware with software, through the bus on the motherboard or other communications subsystems to which the hardware is connected, thus making it possible for data exchange to occur between hardware devices.

With respect to the IDE interface, the IDE controller must provide the reply information including such as the manufacturer name, the serial number of the equipment, and the device type of the hard disk device, etc. when the BIOS is executing the POST code, and to reset the input/output port address of the hard disk devices or the memory locations to proper locations using the operating system. In more details, when the 0th channel of the IDE interface is used, the hard disk device must occupy the input/output port addresses 1F0H˜1F7H and 3F6H; and when the 1th channel of the IDE interface is used, the hard disk device must occupy the input/output port addresses 170H˜177H and 376H, thus allowing the operating system to control the hardware device.

However, the IDE interface of the conventional Peripheral Component Interconnect (PCI) adapter with IDE interface are not of a standard IDE interface, thus requiring to execute additional commands from the BIOS or the driver for implementing the aforementioned reset program, so that the operating system may control the hard disk device to which the PCI adapter with the IDE interface is connected, and be further installed to the hard disk device under the architecture of hard disk data protection technology, thus benefitting from the advantage of this technology.

However, as it needs to drive the hard disk devices using the corresponding driver before entering the operating system, accordingly, the installation of the driver is not being performed under the more convenient Windows® operating system environment. Therefore, it is very difficult and inconvenient for typical users to do. As a result, if the aforementioned steps for installing the driver could not be omitted, then the conventional hard disk data protection technology may fall under the area of professional expertise, which are thereby to be not widely adopted by typical users.

### SUMMARY OF THE INVENTION

A primary objective of the present invention is to provide an adapter for emulating hard disk drive interface, which is mainly to reconfigure the components and interfaces with respect to the IDE interface which were originally configured on the motherboard instead onto a PCI adapter, thus expanding the hard disk drive interface coverage, and which were not supported by the motherboard originally.

Based on the aforementioned objective, the adapter for emulating hard disk drive interface according to the present invention is designed for providing the IDE interface by means of an emulation method without the added installation of a driver for the motherboard that lacks the IDE interface. The controller of the adapter may provide a reply with information such as the manufacturer name, the serial number of the equipment, and the device type of the hard disk device to which it is electrically connected, by responding to the BIOS query though the bus interface, thus emulating the control components of the hard disk drive which are configured on the motherboard, and thereby expanding the hard disk drive interface compatibility range, of which had not been supported by the motherboard originally.

Additional advantages and spirit of the present invention may be realized and attained from the detailed description and appended drawings as follows.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram showing the hardware architecture of a motherboard in accordance with an embodiment of the present invention;

FIG. 2 is a block diagram showing an adapter for emulating hard disk drive interface in accordance with a first embodiment the present invention; and

FIG. 3 is a block diagram showing an adapter for emulating hard disk drive interface in accordance with a second embodiment of the present invention.

### DETAILED DESCRIPTION OF THE PREFERRED EMBODIMENT

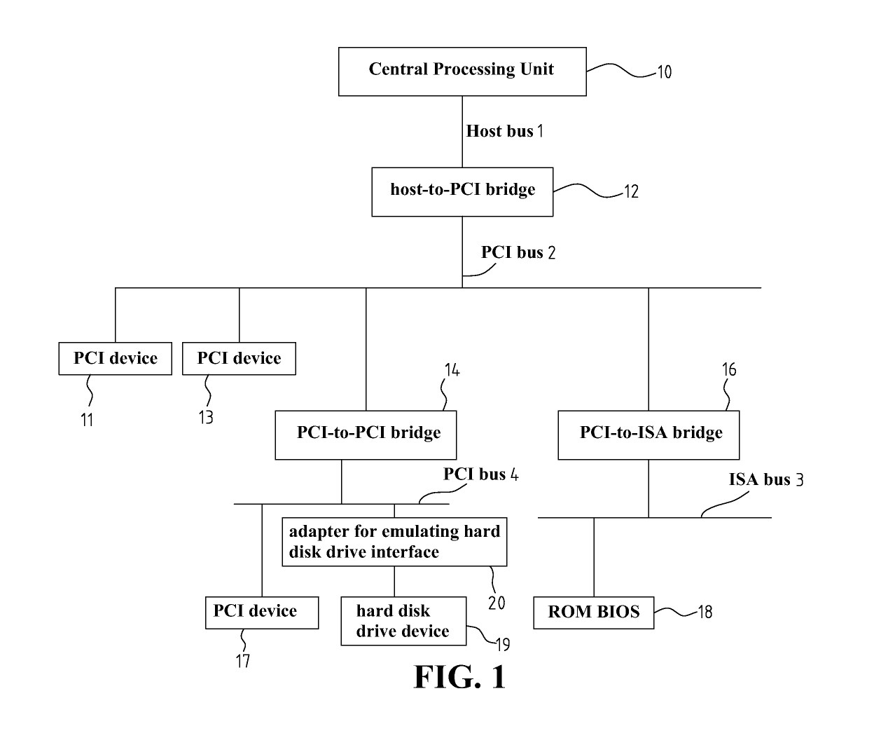

With reference to FIG. 1, FIG. 1 is a block diagram showing the hardware architecture of a motherboard in accordance with an embodiment of the present invention. As shown in FIG. 1 under the hardware architecture of the motherboard according to the present invention, a CPU 10 is electrically connected to a host-to-PCI bridge 12 through a host bus 1, while a PCI bus 2, at the other end of the host-to-PCI bridge 12, is electrically connected to a plurality of standard PCI devices 11 and 13, a PCI-to-PCI bridge 14, and a PCI-to-ISA bridge 16 through a PCI bus 2. The PCI-to-PCI bridge 14 is electrically connected to a PCI device 17 and an adapter for emulating hard disk drive interface 20, through a PCI bus 4 and the PCI interface slot on the motherboard; and a hard disk device 19 is connected to the adapter for emulating hard disk drive interface 20. The PCI-to-ISA bridge 16 is electrically connected to a ROM BIOS 18 through an ISA bus 3.

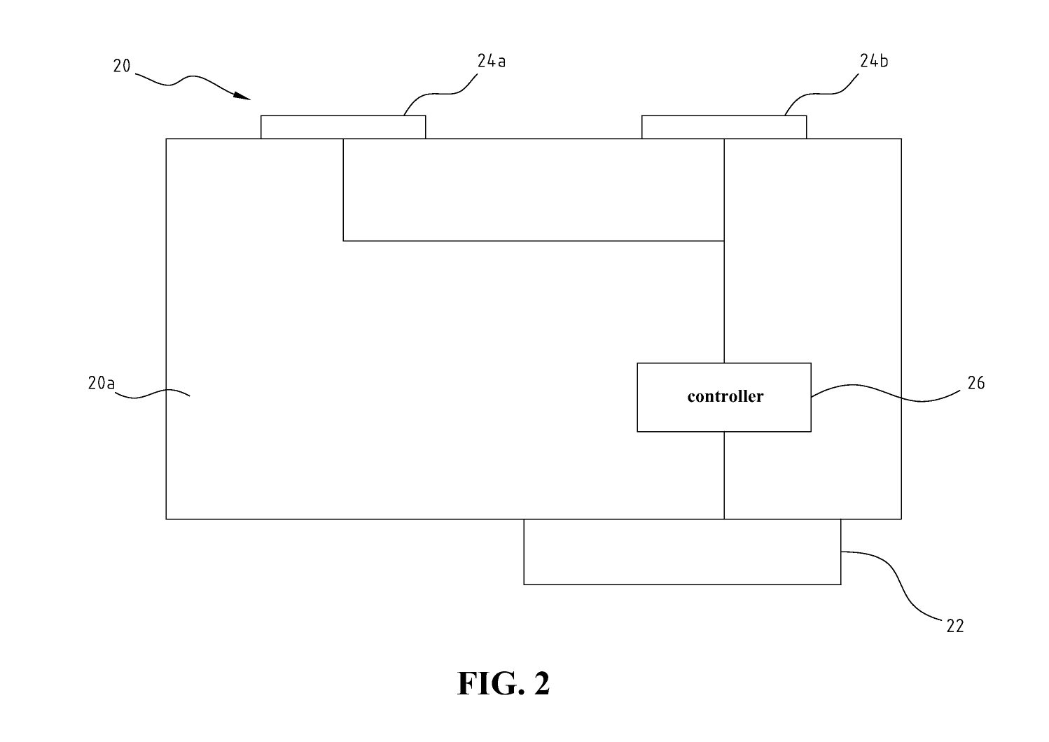

Referring to FIG. 2, FIG. 2 is a block diagram showing an adapter for emulating hard disk drive interface 20 in accordance with a first embodiment of the present invention. As shown in FIG. 2, the adapter for emulating hard disk drive interface 20 includes a plurality of IDE hard disk drive interfaces 24a and 24b, a PCI bus interface 22, and a controller 26 mounted on a circuit board 20a. The IDE hard disk drive interfaces 24a and 24b may be electrically connected up to four hard disk devices. The PCI bus interface 22 may be inserted into the corresponding interface slot on the motherboard, and therefore, is electrically connected to the PCI bus 4 on the motherboard.

In order to expand the support range for the different types of hard disk drive interfaces which had not been previously supported by the motherboard, and to avoid the trouble of having to install the driver, the controller 26 of the adapter 20 may provide reply with information on the manufacturer name, the serial number of the equipment, and the device type of the hard disk device to which it is electrically connected, by responding to the BIOS query though the bus interface, thus emulating the control components of the hard disk drive as if the controller 26 were configured on the motherboard, and therefore expanding the support range of the types of the hard disk drive interface which were originally not supported by the motherboard.

In other words, the adapter for emulating hard disk drive interface 20 is mainly used for assembling the controller and the components which are with respect to the IDE interface originally configured on the motherboard into a single PCI adapter; and to emulate the controller and the components as they were configured on the motherboard, to reply to the query from the BIOS 18 though the bus interface 22, and to execute a reset program for the hard disk device 19 to reset the input/output port location or the memory location. In this way, the operating system may control the hard disk device 19, of which the adapter 20 is connected, under the control of the CPU 10; thus the operating system could be installed to the hard disk device within the hard disk data protection technology architecture (which may be integrated into the adapter 20), and therefore realizing the advantage of this technology. Additionally, the adapter 20 also allows the technology for hard disk data protection to control the remaining space based upon the characteristics that the IDE interface is able to support two hard disk using a single interface. Notably, if there are information or data needed to be written into the hard disk device 19 or to be read from the hard disk device 19, the controller 26 should using conventional native PCI-to-IDE technology for processing.

The aforementioned controller 26 may use Field Programmable Gate-Array (FPGA), which is a semiconductor device containing programmable logic components and programmable logic gate components. Currently, using mainstream technology of modern Integrated Circuits design validation, circuit layout implemented using hardware description languages such as Verilog or VHSIC (Very High Speed Integrated Circuit) Hardware Description Language (VHDL), may be quickly burned to FPGA for process validation through the place-and-route process. The programmable logic components can be programmed to implement circuits of basic logic gates such as AND, OR, XOR, NOT or the more complex combinational functions such as decoders or math functions. In most FPGAs, these programmable logic components also include memory elements such as flip-flops or other more complete memory blocks.

Additionally, the hard disk drive interface 24a and 24b, apart from being Parallel ATA interface or PATA interface, may also be Serial ATA (SATA) interface.

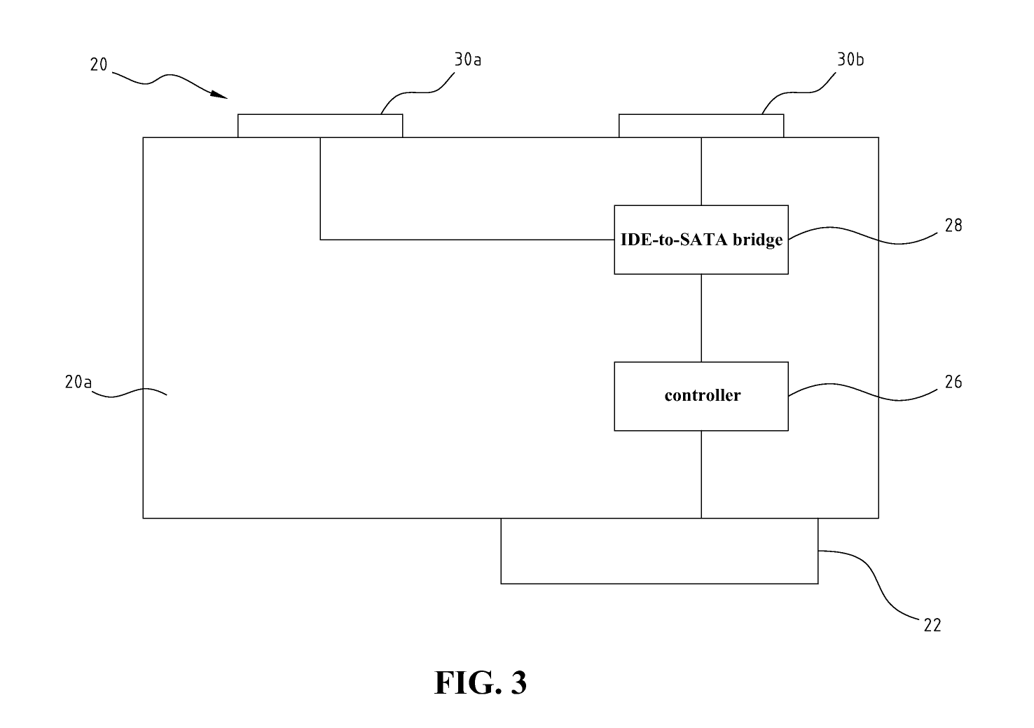

Referring to FIG. 3, FIG. 3 is a block diagram showing an adapter for emulating hard disk drive interface 20 in accordance with a second embodiment of the present invention. As shown in FIG. 3, the adapter for emulating hard disk drive interface 20 includes the IDE hard disk drive interfaces 24a and 24b, a PCI bus interface 22, and a controller 26 mounted on a circuit board 20a, and additionally, an IDE-to-SATA bridge 28 is configured between a plurality of SATA hard disk drive interfaces 30a and 30b. In this way, the controller 26, indirectly via the IDE-to-SATA bridge 28, may perform the control operation of the hard disk drive through the hard disk drive interfaces 30a and 30b.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An adapter for emulating hard disk drive interface, to be inserted into a corresponding interface slot on a motherboard, and the motherboard comprising
at least a BIOS and a CPU, and the adapter, comprising:
a hard disk drive interface, electrically connected to a hard disk device;
a bus interface, inserted into a corresponding interface slot on the motherboard, and electrically connected to a bus on the motherboard; and
a controller, replying with information on the manufacturer name, the serial number of the equipment, and the device type of the hard disk device which is electrically connected to, by responding to the BIOS query though the bus interface, thus emulating control components of the hard disk drive wherein configured on the motherboard, and thereby expanding the support range for the number of hard disk interface types wherein had not been originally supported by the motherboard.

2. The adapter as claimed in claim 1, wherein the controller executes a reset program for the hard disk device for resetting the input and output port locations or the memory locations.

3. The adapter as claimed in claim 1, wherein the controller directly controls the operation of the hard disk device through the hard disk drive interface, when the hard disk drive interface is a PATA interface.

4. The adapter as claimed in claim 1, wherein the controller directly controls the operation of the hard disk device through the hard disk drive interface indirectly via an IDE-to-SATA bridge, when the hard disk drive interface is a SATA interface.
